(19) United States
(12) Patent Application Publication
(10) Pub. No.: US 2009/0089497 A1
(43) Pub. Date: Apr. 2, 2009

(54) METHOD OF DETECTING PRE-OPERATING SYSTEM MALICIOUS SOFTWARE AND FIRMWARE USING CHIPSET GENERAL PURPOSE DIRECT MEMORY ACCESS HARDWARE CAPABILITIES

(76) Inventors: Yuriy Bulygin, Hillsboro, OR (US); David Samyde, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/864,794

(22) Filed: Sep. 28, 2007

(51) Int. Cl. G06F 21/00; G06F 12/00; G06F 12/14

(52) U.S. Cl. 711/112; 726/24; 711/163; 711/E12.093; 711/E12.001

(57) ABSTRACT

In some embodiments, a method of detecting pre-operating system malicious software and firmware using chipset general purpose direct memory access hardware capabilities is presented. In this regard, a security agent is introduced to access system memory used by instructions executing on a host processor or microcontroller, to copy contents from the system memory to an internal chipset memory, and to scan the internal memory with an embedded processor for a malicious software pattern. Other embodiments are also disclosed and claimed.

### FIELD OF THE INVENTION

Embodiments of the present invention generally relate to the information security, and, more particularly to a method of detecting pre-operating system malicious software and firmware using chipset general purpose direct memory access hardware capabilities.

### BACKGROUND OF THE INVENTION

Malicious software is continually evolving to avoid detection. With the introduction of hardware virtualization technologies, malicious software could execute in CPU root mode as a virtual machine monitor or a hypervisor and use hardware virtualization capabilities to avoid detection by current anti-malware software, for example by hijacking access attempts to memory in which the malware resides.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing the security agent, in accordance with one example embodiment of the invention;

FIG. 2 is a block diagram of an example security agent architecture, in accordance with one example embodiment of the invention;

FIG. 3 is a flow chart of an example method of detecting pre-operating system malicious software and firmware using chipset general purpose direct memory access hardware capabilities, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

Embodiments of the present invention are generally directed to a method of detecting pre-operating system malicious software and firmware using chipset general purpose direct memory access hardware capabilities. In this regard, in accordance with but one example implementation of the broader teachings of the present invention, a security agent is introduced. In accordance with but one example embodiment, the security agent employs an innovative method to detect and respond to virtualization malware and other malicious software. According to one example method, the security agent may be able to access root level privileged memory addresses and uses an embedded processor that is not virtualizable. For purposes of this invention the term pre-operating system malicious software and firmware is intended to include any malicious software or firmware that utilizes virtualization to avoid detection or that can persist in regions of memory to which the OS doesn't have access. Pre-operating system malicious code may include, for example, malicious software utilizing CPU virtualization technology (virtual machine monitor), malicious chipset firmware, malicious OS or OS loader, malicious BIOS or extensible firmware interface (EFI) drivers and, potentially, malicious software management interrupt (SMI) handling code

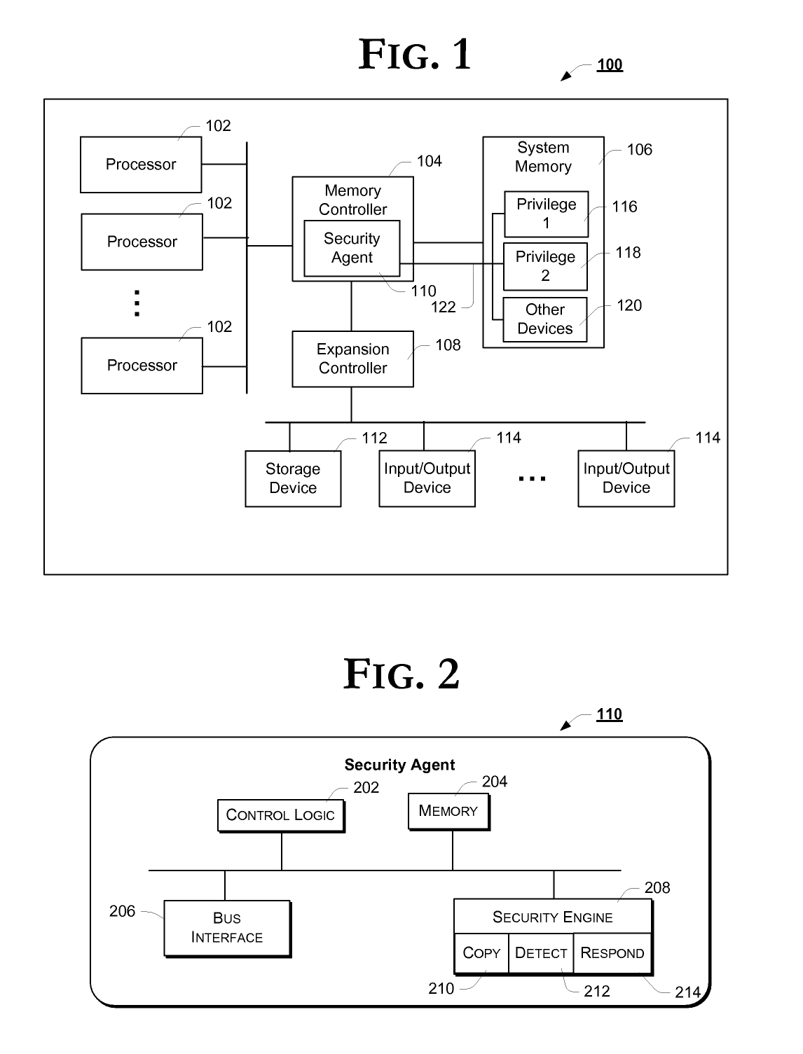

FIG. 1 is a block diagram of an example electronic appliance suitable for implementing the security agent, in accordance with one example embodiment of the invention. Electronic appliance 100 is intended to represent any of a wide variety of traditional and non-traditional electronic appliances, laptops, desktops, servers, disk drives, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, system memory 106, expansion controller 108, security agent 110, storage device 112, input/output device(s) 114, privilege 1 memory region 116, privilege 2 memory region 118, other memory devices 120, and backbone 122 coupled as shown in FIG. 1. Security agent 110, as described more fully hereinafter, may well be used in electronic appliances of greater or lesser complexity than that depicted in FIG. 1. Also, the innovative attributes of security agent 110 as described more fully hereinafter may well be embodied in any combination of hardware and software. While shown as being part of memory controller 104, security agent 110 may well be a separate component or part of another component, for example processor(s) 102.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 106 with the other components of electronic appliance 100. In one embodiment, the connection between processor(s) 102 and memory controller 104 may be a point-to-point serial link. In another embodiment, memory controller 104 may be referred to as a memory controller hub. In another embodiment, memory controller 104 may include an embedded processor and an internal memory which implement security agent 110 as described hereinafter.

System memory 106 may represent any type of memory device(s) used to store data and instructions that may have been or will be used by processor(s) 102. Typically, though the invention is not limited in this respect, system memory 106 will consist of dynamic random access memory (DRAM). In one embodiment, system memory 106 may consist of Rambus DRAM (RDRAM). In another embodiment, system memory 106 may consist of double data rate synchronous DRAM (DDRSDRAM). The present invention, however, is not limited to the examples of memory mentioned here.

Expansion controller 108 may represent any type of chipset or control logic that interfaces expansion devices with the other components of electronic appliance 100. In one embodiment, expansion controller 108 may be referred to as a south bridge. In one embodiment, expansion controller 108 complies with Peripheral Component Interconnect (PCI) Express Base Specification, Revision 1.0, PCI Special Interest Group, released Apr. 29, 2002.

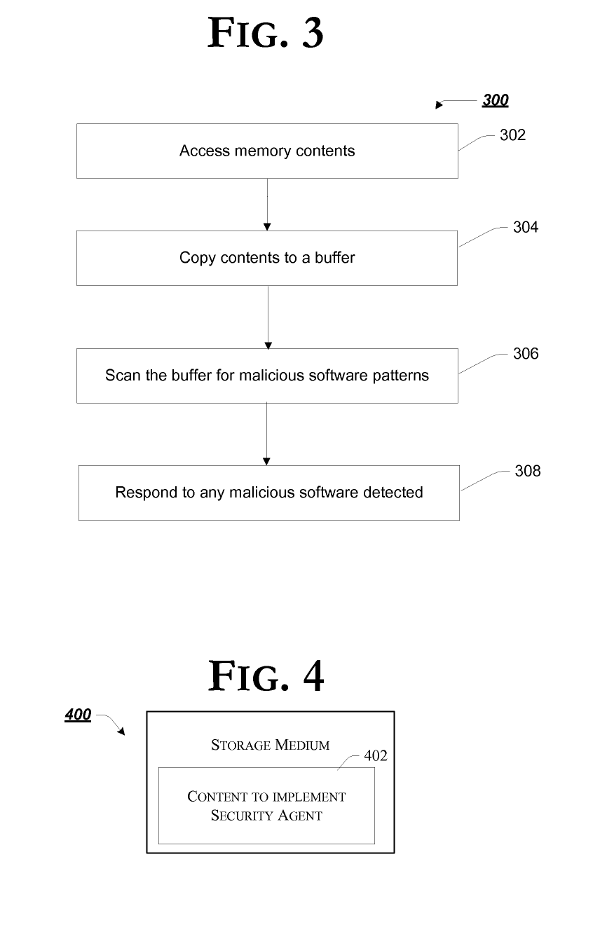

Security agent 110 may have an architecture as described in greater detail with reference to FIG. 2. Security agent 110 may also perform one or more methods to detect pre-operating system malicious software and firmware using chipset general purpose direct memory access hardware capabilities, such as the method described in greater detail with reference to FIG. 3.

Storage device 112 may represent any storage device used for the long term storage of data. In one embodiment, storage device 112 may be a hard disk drive.

Input/output (I/O) device(s) 114 may represent any type of device, peripheral or component that provides input to or processes output from electronic appliance 100. In one embodiment, though the present invention is not so limited, I/O device 114 may include a network interface controller.

System memory 106 may include contents with varying privileges or access restrictions. Privilege 1 memory region 116 may comprise restricted memory not accessible from the OS, for example, protected DRAM ranges for VMX root mode code and data, DRAM regions stolen for the chipset firmware, legacy range (lower 1 MB of physical memory), while privilege 2 memory region 118 may comprise non-restricted memory accessible from the OS. Other memory devices 120 may comprise restricted and non-restricted memory devices and may include stolen memory (DRAM regions stolen for chipset firmware), SPI flash, chipset SRAM.

Backbone 122 may couple security agent 110 with restricted and non-restricted memory of system memory 106. In one embodiment, backbone 122 comprises a manageability engine backbone that provides GPDMA capabilities.

FIG. 2 is a block diagram of an example security agent architecture, in accordance with one example embodiment of the invention. As shown, security agent 110 may include one or more of control logic 202, memory 204, bus interface 206, and security engine 208 coupled as shown in FIG. 2. In accordance with one aspect of the present invention, to be developed more fully below, security agent 110 may include a security engine 208 comprising one or more of copy services 210, detect services 212, and/or respond services 214. It is to be appreciated that, although depicted as a number of disparate functional blocks, one or more of elements 202-214 may well be combined into one or more multi-functional blocks. Similarly, security engine 208 may well be practiced with fewer functional blocks, i.e., with only detect services 212, without deviating from the spirit and scope of the present invention, and may well be implemented in hardware, software, firmware, or any combination thereof. In this regard, security agent 110 in general and security engine 208 in particular are merely illustrative of one example implementation of one aspect of the present invention. As used herein, security agent 110 may well be embodied in hardware, software, firmware and/or any combination thereof.

As introduced above, security agent 110 may have the ability to detect pre-operating system malicious software and firmware. In one embodiment, security agent 110 can access restricted memory contents not accessible from the OS. In another embodiment, security agent 110 accesses memory contents directly and is not subject to VMX root interception.

As used herein control logic 202 provides the logical interface between security agent 110 and its host electronic appliance 100. In this regard, control logic 202 may manage one or more aspects of security agent 110 to provide a communication interface from electronic appliance 100 to software, firmware and the like, e.g., instructions being executed by processor(s) 102. In one embodiment, control logic 202 is an embedded processor that performs the functions of security engine 208.

According to one aspect of the present invention, though the claims are not so limited, control logic 202 may selectively invoke the resource(s) of security engine 208. As part of an example method for detecting pre-operating system malicious software and firmware using chipset general purpose direct memory access hardware capabilities, as explained in greater detail with reference to FIG. 3, control logic 202 may selectively invoke copy services 210 that may access memory contents and copy the contents to a buffer. Control logic 202 also may selectively invoke detect services 212 or respond services 214, as explained in greater detail with reference to FIG. 3, to scan the buffer for malicious software patterns and to respond to any malicious code detected, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may also include, among others: polymer memory, battery backed DRAM, RDRAM, NAND/NOR memory, flash memory, or Ovonics memory. In one embodiment, memory 204 may be a portion of system memory 106. In another embodiment, memory 204 may be an internal buffer of memory controller 104. Memory 204 may be used by security engine 208 to store contents of system memory 106, for example.

Bus interface 206 provides a path through which security agent 110 can communicate with other components of electronic appliance 100, for example to access system memory 106 through backbone 122. In one embodiment, bus interface 206 may represent a manageability engine interface.

Copy services 210, as introduced above, may provide security agent 110 with the ability to access memory contents and to copy the contents to a buffer. In one embodiment, copy services 210 performs a general purpose direct memory access (GPDMA) operation to move contents from system memory, for example privilege 1 memory region 116 or privilege 2 memory region 118 or other memory devices 120, to an internal memory buffer, for example memory 204.

As introduced above, detect services 212 may provide security agent 110 with the ability to scan the buffer for malicious software patterns. In one example embodiment, detect services 212, scans the buffer for patterns of data (e.g. byte sequences) associated with known malicious software. In one example embodiment, malicious software patterns may be separately stored in memory 204. In another embodiment, detect services 212 may utilize other techniques and technologies known in the art to detect malicious software and firmware within the buffer.

Respond services 214, as introduced above, may provide security agent 110 with the ability to respond to any malicious software detected. In one embodiment respond services 214, responds to the detection of malicious software by removing the malicious software from system memory 106. In one embodiment, respond services 214 interrupt the operating system and display a message on a display device. In another embodiment, respond services 214 may utilize other techniques and technologies known in the art to respond to malicious software and firmware found within the buffer.

FIG. 3 is a flow chart of an example method of detecting pre-operating system malicious software and firmware using chipset general purpose direct memory access hardware capabilities, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with control logic 202 selectively invoking copy services 210 to access (302) and copy (304) memory contents to a buffer. In one example embodiment, copy services 210 accesses and copies restricted memory contents from system memory 106 to memory 204 through backbone 222. In one embodiment, copy services 210 performs a GPDMA to move contents into memory 204.

Control logic 202 may then selectively invoke detect services 212 to scan (306) the buffer for malicious software patterns. In one example embodiment, detect services 212 scans memory 204 using a stored set of malicious software patterns.

Next, respond services 214 may respond (308) to any malicious software detected. In one embodiment, respond services 214 may remove the malicious software from system memory 106. In another embodiment, respond services 214 may place electronic appliance 100 into an alternate mode and prompt a user to take appropriate actions.

FIG. 4 illustrates a block diagram of an example storage medium comprising content which, when accessed, causes an electronic appliance to implement one or more aspects of the security agent 110 and/or associated method 300. In this regard, storage medium 400 includes content 402 (e.g., instructions, data, or any combination thereof) which, when executed, causes the appliance to implement one or more aspects of security agent 110, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
accessing with an embedded processor system memory used by instructions executing on a host processor or microcontroller;
copying contents with the embedded processor from the system memory to an internal chipset memory; and
scanning the internal memory with the embedded processor for a malicious software pattern.

2. The method of claim 1, further comprising:
responding to a detection of the malicious software pattern.

3. The method of claim 2, wherein responding to a detection of the malicious software pattern comprises:
removing the malicious software from the system memory.

4. The method of claim 1, wherein copying contents with the embedded processor from the system memory to an internal chipset memory comprises:
performing a general purpose direct memory access (GPDMA) with the embedded processor to move contents into the internal chipset memory.

5. The method of claim 1, wherein accessing with an embedded processor system memory used by instructions executing on a host processor or microcontroller comprises:
accessing system memory which is protected from access by an operating system.

6. The method of claim 1, wherein accessing with an embedded processor system memory used by instructions executing on a host processor or microcontroller comprises:
accessing a memory chosen from the group consisting of: DRAM regions non-accessible to host OS or software such as protected ranges for VMX root mode operation, stolen memory (DRAM memory regions stolen for chipset), legacy region (lower 1 MB of physical memory), ICH SPI flash, MCH SRAM, NOR/NAND flash memory etc.

7. An electronic appliance, comprising:
a host processor to perform instructions from a program;
memory coupled with the processor to store program code and data; and
a security engine including direct memory access hardware and an internal memory, to access the system memory, to copy the contents to an internal memory, and to scan the copied contents for a malicious software pattern or verify copied contents against known good software or firmware.

8. The electronic appliance of claim 7, further comprising:
the security engine to respond to a detection of the malicious software pattern.

9. The electronic appliance of claim 7, wherein the security engine to copy the program data to an internal memory comprises:
the security engine to perform a general purpose direct memory access (GPDMA) to move contents into the internal memory.

10. The electronic appliance of claim 7, further comprising:
the security engine coupled to restricted memory not accessible from an operating system, the security engine to access the restricted memory.

11. The electronic appliance of claim 10, wherein the restricted memory comprises
memory from the group consisting of: stolen memory (DRAM memory regions stolen for chipset), internal MCH SRAM or ROM.

12. The electronic appliance of claim 7, further comprising:
a hard disk drive.

13. The electronic appliance of claim 7, wherein the security agent comprises a memory controller hub with an embedded microcontroller executing firmware instructions.

14. The electronic appliance of claim 7, further comprising:
the security agent to access the contents of the system memory using a direct memory access hardware engine.

15. The electronic appliance of claim 7, further comprising:
a manageability engine backbone to couple the security engine with the memory.
